(19) United States
(12) Patent Application Publication
(10) Pub. No.: US 2010/0230218 A1
(43) Pub. Date: Sep. 16, 2010

(54) HYDRAULIC CALIPER BRAKE ASSEMBLY WITH SELF-ADJUSTING FEATURE

(75) Inventor: Wayne-Ian Moore, Changhua City (TW)

Correspondence Address: Yen Jung Sung, 21-80 38 St, #C8, Astoria, NY, 11105, US

(73) Assignee: ASHIMA LTD., Changhua City (TW)

(21) Appl. No.: 12/402,496

(22) Filed: Mar. 12, 2009

(51) Int. Cl. F16D 55/228

(52) U.S. Cl. 188/71.8

(57) ABSTRACT

A hydraulic caliper brake assembly with self-adjusting feature includes a cylindrical body, an elastomer, a pushing rod, a force resisting member, and a retaining ring. The cylindrical body has a chamber. The elastomer is sealing disposed in the chamber and has a receiving hole. The elastomer provides a resilient force. The pushing rod is sealingly received in the receiving hole. The pushing rod has a shank extended therefrom and protruded into the chamber. The shank has a shoulder. The force resisting member is sleeved on the shank. The force resisting member abuts against the chamber to provide a resisting force. The retaining ring is disposed in one end of the shank. The retaining ring is moved with the pushing rod.

### BACKGROUND OF THE INVENTION

1. Field of the Invention

The present invention relates to a hydraulic caliper brake assembly, and more particularly to a hydraulic caliper brake assembly with self-adjusting feature.

2. Description of Related Art

Referring to U.S. application Ser. No. 12/131,940, a conventional hydraulic caliper brake assembly is disclosed. The conventional hydraulic caliper brake assembly in accordance with the prior art comprises a housing having an open chamber and an elastomer sealingly mounted in the chamber for containing brake oil. The elastomer includes a skirt connected to an inner peripheral of the chamber, a projection adapted to a brake shoe, and a U-shaped portion positioned between the skirt and the projection for providing the displacement of the projection. A plate is disposed between the housing and the elastomer. A shoulder mounted on the plate is corresponded to an annular flange mounted on elastomer for retaining the elastomer. When hydraulic pressure is greater than the elastic force of the elastomer, the projection of the elastomer is pushed toward the brake shoe to achieve the braking purpose. On the contrary, the projection of the elastomer is restored to a free condition.

After a certain period of usage, the brake shoe has worn due to friction between the brake shoe and the disk/rotor. The thickness of the brake shoe is reduced. Therefore, the distance of travel for the projection of the elastomer is increased. The travel can be greater than displacement achievable in the lever, such that the rider is unable to pressurize the system and hence loss of brakes.

The present invention has arisen to mitigate and/or obviate the disadvantages of the conventional hydraulic caliper brake assembly.

### SUMMARY OF THE INVENTION

The main objective of the present invention is to provide an improved hydraulic caliper brake assembly, in that a hydraulic caliper brake assembly with self-adjusting feature is acquired.

To achieve the objective, the hydraulic caliper brake assembly with self-adjusting feature includes a cylindrical body, an elastomer received in the cylindrical, a pushing rod connected to the elastomer, a force resisting member connected to the pushing rod, and a retaining ring connected to the pushing rod. The cylindrical body has a chamber defined therein. The elastomer is sealing disposed in the chamber for containing hydraulic oil. The elastomer has a receiving hole defined therein. The elastomer provides a resilient force. The pushing rod is sealingly received in the receiving hole. The pushing rod has a shank extended therefrom and protrudes into the chamber. The shank has a shoulder formed therein. The force resisting member is sleeved on the shank. The force resisting member abuts against the chamber to provide a resisting force. The retaining ring is disposed in one end of the shank and is moved with the pushing rod. When a pressure in the chamber is greater than the resisting force and the retaining ring abuts against the force resisting member, the force resisting member is pushed by the retaining ring to move. When the pressure in the chamber is less than the resilient force and the shoulder abuts against the force resisting member, the pushing rod is stopped by the force resisting member.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hydraulic caliper brake assembly with self-adjusting feature in accordance with the present invention;

FIG. 2 is a cross-sectional side elevation view of the hydraulic caliper brake assembly with self-adjusting feature in accordance with the present invention, showing the hydraulic caliper brake assembly in a release condition;

FIG. 3 is a cross-sectional side elevation view of the hydraulic caliper brake assembly with self-adjusting feature in accordance with the present invention, showing the hydraulic caliper brake assembly in a braking condition;

FIG. 4 is a cross-sectional side elevation view of the hydraulic caliper brake assembly with self-adjusting feature in accordance with the present invention, showing the retaining ring abuts against the force resisting member after the brake shoe has worn;

FIG. 5 is a cross-sectional side elevation view of the hydraulic caliper brake assembly with self-adjusting feature in accordance with the present invention, showing the hydraulic caliper brake assembly in a braking condition after the brake shoe has worn; and

FIG. 6 is a cross-sectional side elevation view of the hydraulic caliper brake assembly with self-adjusting feature in accordance with the present invention, showing the hydraulic caliper brake assembly in a release condition after the brake shoe has worn.

### DETAILED DESCRIPTION OF THE INVENTION

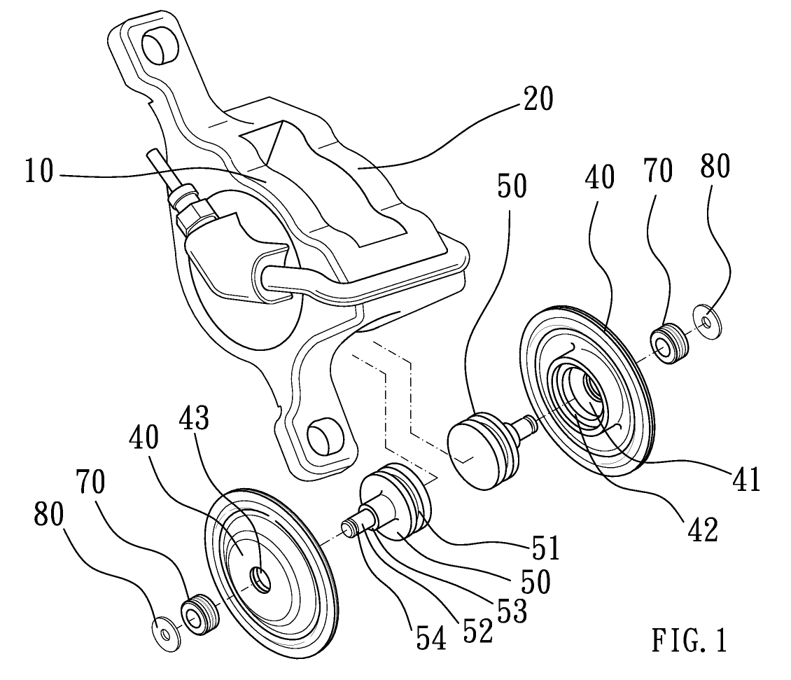

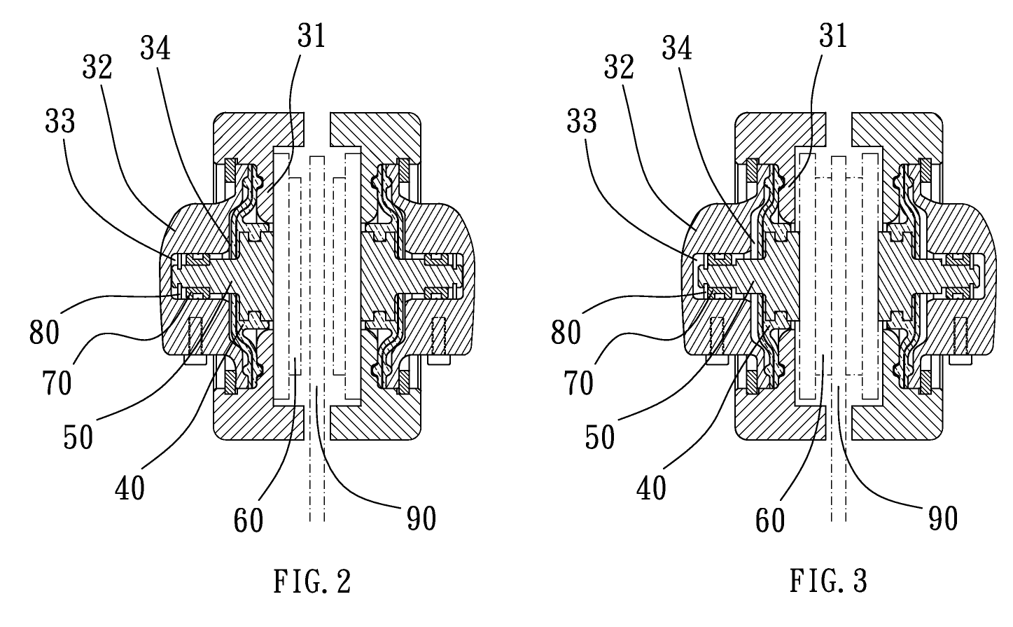

Referring to the drawings and initially to FIGS. 1-2, a hydraulic caliper brake assembly with self-adjusting feature in accordance with the present invention comprises a left cylindrical body 10 and a right cylindrical body 20 connected to the left cylindrical body 10.

In the preferred embodiment, the left cylindrical body 10 and the right cylindrical body 20 are symmetrical to each other for providing a symmetrical and uniform braking force. In the following description, the embodiment is described in a single cylindrical body 10, 20.

The cylindrical body 10, 20 is hollow. The cylindrical body 10, 20 has an annular flange 31 formed in an inner peripheral thereof. The cylindrical body 10, 20 has a side cover 32 sealingy disposed in the inner peripheral thereof. The side cover 32 has a bore 33 defined therein facing the flange 31. The cylindrical body 10, 20 has a chamber 34 defined between the flange 31 and the side cover 32.

The hydraulic caliper brake assembly with self-adjusting feature in accordance with the present invention further comprises an elastomer 40 sealingy disposed between the side cover 32 and the flange 31. The elastomer 40 is disposed in the chamber 34 and seals the chamber 34. The elastomer 40 is made of rubber. The elastomer 40 has a receiving hole 41 defined in a center thereof. The elastmoer 40 has an annular protrusion 42 formed in an inner peripheral of the receiving hole 41. The elastmoer 40 has a through hole 43 defined in a bottom of the receiving hole 41.

The hydraulic caliper brake assembly with self-adjusting feature in accordance with the present invention further comprises a pushing rod 50 sealingly receiving in the receiving hole 41 of the elastomer 40. The pushing rod 50 is adapted to be connected to a brake shoe 60. The pushing rod 50 has a first annular groove 51 defined in an outer peripheral thereof and corresponding to the annular protrusion 42 of the elastomer 40. The annular protrusion 42 is engaged with the first annular groove 51 for firmly connecting the elastomer 40 and the pushing rod 50 and providing the sealing effort. The pushing rod 50 has a shank 52 extended therefrom. The shank 52 of the pushing rod 50 has a shoulder 53 formed in a middle thereof. The shank 52 has a second annular groove 54 defined therein. The shank 52 passes through the through hole 43 in the elastomer 40 and protrudes into the chamber 34. The chamber 34 is filled with hydraulic oil. The pushing rod 50 is made of plastic or light metal (i.e. alumina alloy) for reducing the weight.

The hydraulic caliper brake assembly with self-adjusting feature in accordance with the present invention further comprises a force resisting member 70 sleeved on the shank 52 of the pushing rod 50 and a retaining ring 80 engaged with the second annular groove 54 in the shank 52 of the pushing rod 50. The force resisting member 70 is sized to fit a diameter of the bore 33 such that the force resisting member 70 provides a resisting force produced by friction between the force resisting member 70 and the bore 33.

Referring to FIGS. 2 and 3, the operation of the hydraulic caliper brake assembly with self-adjusting feature in accordance with the present invention is illustrated. FIG. 2 shows the hydraulic caliper brake assembly is in a release condition which means the hydraulic caliper brake assembly does not perform the brake. The elastomer 40 provides a resilient force to push the pushing rod 50 toward the chamber 34. In the meantime, the shoulder 53 of the shank 52 abuts against the force resisting member 70. The resisting force provided by the force resisting member 70 is greater than the resilient force provided by the elastomer 40 such that the pushing rod 50 is stopped. FIG. 3 shows the hydraulic caliper brake assembly is in a braking condition which means the hydraulic caliper brake assembly performs the brake. The hydraulic oil pressure in the chamber 34 is raised such that the pushing rod 50 is pushed toward the brake shoe 60. When the brake shoe 60 abuts against a disk 90, the hydraulic caliper brake assembly performs the brake. When the hydraulic oil pressure in the chamber 34 is less than the resilient force, the elastomer 40 pushes the pushing rod 50 back to the release condition as shown in FIG. 2.

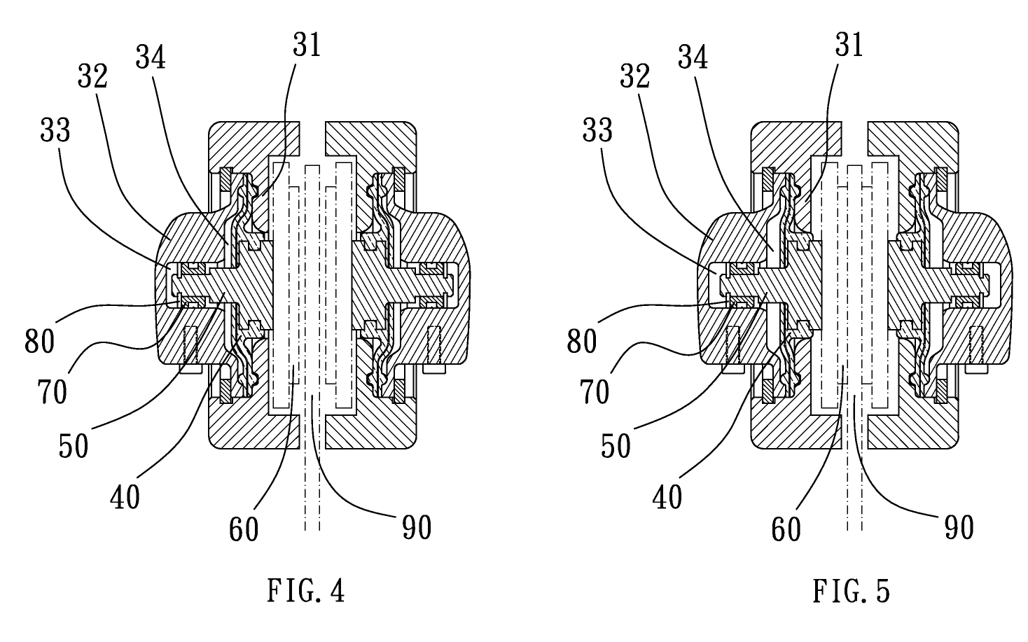

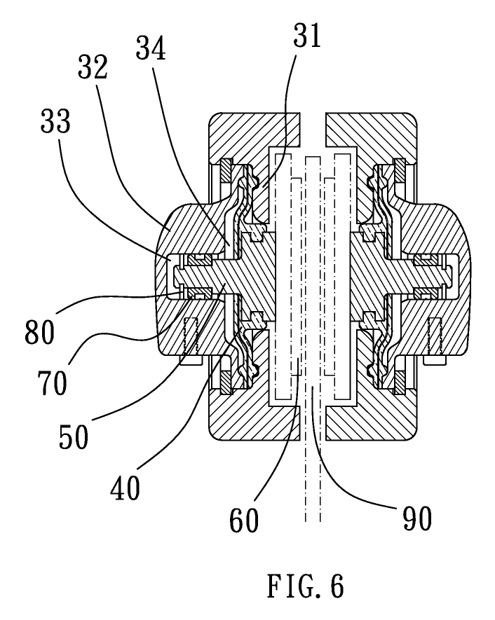

After a certain period of usage, the brake shoe 60 has worn. The thickness of the brake shoe 60 is decreased. Referring to FIGS. 4-6, the self-adjusting operation of the hydraulic caliper brake assembly is illustrated. When the hydraulic oil pressure in the chamber 34 is raised to push the pushing rod 50 toward the brake shoe 60, the retaining ring 80 abuts against the force resisting member 70 as shown in FIG. 4. The brake shoe 60 does not abut against the disk 90 due to the decreased thickness of brake shoe 60. The hydraulic oil pressure in the chamber 34 is kept raising and then greater than the resisting force provided by the force resisting member 70 such that the retaining ring 80 pushes the force resisting member 70 toward the brake shoe 60. The pushing rod 50, the retaining ring 80, and the force resisting member 70 are moved until the brake shoe 60 abuts against the disk 90 as shown in FIG. 5. FIG. 5 shows the hydraulic caliper brake assembly in a braking condition after the brake shoe 60 has worn. When the hydraulic oil pressure in the chamber 34 is less than the resilient force, the elastomer 40 pushes the pushing rod 50 back. When the shoulder 53 of the shank 52 abuts against the force resisting member 70, the pushing rod 50 is stopped due to the resisting force provided by the force resisting member 70 as shown in FIG. 6. The hydraulic caliper brake assembly is in a release condition after the brake shoe 60 has worn.

The distance of travel between the brake shoe 60 and the disk 90 is kept constant due to the self-adjusting feature of the hydraulic caliper brake assembly. Therefore, the sensitivity of the hydraulic caliper brake assembly in accordance with the present invention is well.

Although the invention has been explained in relation to its preferred embodiment, it is to be understood that many other possible modifications and variations can be made without departing from the spirit and scope of the invention as hereinafter claimed.

What is claimed is:

1. A hydraulic caliper brake assembly with self-adjusting feature comprising:
a cylindrical body having a chamber defined therein;
an elastomer sealing disposed in the chamber for containing hydraulic oil, the elastomer having a receiving hole defined therein, the elastomer providing a resilient force;
a pushing rod sealingly received in the receiving hole, the pushing rod having a shank extended therefrom and protruded into the chamber, the shank having a shoulder formed therein;
a force resisting member sleeved on the shank, the force resisting member abutted against the chamber to provide a resisting force; and
a retaining ring disposed in one end of the shank, wherein the retaining ring is moved with the pushing rod;
wherein when a pressure in the chamber is greater than the resisting force and the retaining ring abuts against the force resisting member, the force resisting member is pushed by the retaining ring to move; when the pressure in the chamber is less than the resilient force and the shoulder abuts against the force resisting member, the pushing rod is stopped by the force resisting member.

2. The hydraulic caliper brake assembly with self-adjusting feature as claimed in claim 1, wherein the elastomer is made of rubber.

3. The hydraulic caliper brake assembly with self-adjusting feature as claimed in claim 1, wherein the elastomer has an annular protrusion formed in an inner peripheral of the receiving hole.

4. The hydraulic caliper brake assembly with self-adjusting feature as claimed in claim 3, wherein the pushing rod has a first annular groove defined in an outer peripheral thereof for sealingly receiving the annular protrusion.

5. The hydraulic caliper brake assembly with self-adjusting feature as claimed in claim 1, wherein the shank has a second annular groove defined in an outer peripheral thereof for engaging the retaining ring.

6. A hydraulic caliper brake assembly with self-adjusting feature comprising:
a hollow cylindrical body having a flange formed in a inner peripheral thereof, the cylindrical body having a side cover sealing disposed in the inner peripheral thereof, the side cover having a bore formed therein and facing the flange, the cylindrical body having a chamber defined between the flange and the side cover;
an elastomer sealing disposed in the chamber and between the flange and the side cover for containing hydraulic oil, the elastomer having a receiving hole defined therein, the elastomer providing a resilient force;
a pushing rod sealingly received in the receiving hole, the pushing rod having a shank extended therefrom and protruded into the bore, the shank having a shoulder formed therein;
a force resisting member sleeved on the shank, the force resisting member abutted against a inner peripheral of the bore to provide a resisting force; and
a retaining ring disposed in one end of the shank, wherein the retaining ring is moved with the pushing rod;
wherein when a pressure in the chamber is greater than the resisting force and the retaining ring abuts against the force resisting member, the force resisting member is pushed by the retaining ring to move; when the pressure in the chamber is less than the resilient force and the shoulder abuts against the force resisting member, the pushing rod is stopped by the force resisting member.

7. The hydraulic caliper brake assembly with self-adjusting feature as claimed in claim 6, wherein the elastomer is made of rubber.

8. The hydraulic caliper brake assembly with self-adjusting feature as claimed in claim 6, wherein the elastomer has an annular protrusion formed in an inner peripheral of the receiving hole.

9. The hydraulic caliper brake assembly with self-adjusting feature as claimed in claim 8, wherein the pushing rod has a first annular groove defined in an outer peripheral thereof for sealingly receiving the annular protrusion.

10. The hydraulic caliper brake assembly with self-adjusting feature as claimed in claim 6, wherein the shank has a second annular groove defined in an outer peripheral thereof for engaging the retaining ring.
